(19) United States
(12) Patent Application Publication
(10) Pub. No.: US 2008/0165532 A1
(43) Pub. Date: Jul. 10, 2008

(54) GAS LIGHT BULB OF HIGH LUMINANCE

(76) Inventors: Lung Chen, Hu-Kou (TW); Hui-Hsiang Feng, Hu-Kou (TW); Ya-Chuan Yeh, Hu-Kou (TW)

Correspondence Address: LEONG C LEI, PMB # 1008, 1867 YGNACIO VALLEY ROAD, WALNUT CREEK, CA, 94598, US

(21) Appl. No.: 11/621,581

(22) Filed: Jan. 10, 2007

(51) Int. Cl. F21V 7/00; F21V 1/00

(52) U.S. Cl. 362/235; 362/310

(57) ABSTRACT

A gas light bulb of high luminance is disclosed. The light bulb comprises a reflective shade and light bulb units mounted and supported within the reflective shade, characterized in that the internal surface of the reflective shade is provided with reflective mirror and the center position of the reflective shade is extended to form a neck portion and the light bulb includes at least two rows of light bulb units, and each light bulb unit has a space for filling with a gas and the space includes a first electrode and a second electrode, and the first and the second electrode are respectively supported and positioned by a conductor, and the conductor is connected to a metallic conductive wire as an electrical point.

### BACKGROUND OF THE INVENTION

(a) Technical Field of the Invention

The present invention relates to high luminance light bulb, and specifically, a light bulb which is used in projectors, automobiles or other devices which require specific illumination requirements.

(b) Description of the Prior Art

Gas light bulb, such as UHP bulb, UHE bulb satisfies the requirements of light value and light hue for projectors and provides an entire visible light emission spectrum, therefore, it is used as the light source of the projector. The size of light value of the light is a critical factor affecting the quality of a projector. If the light value is high, the device provides a high luminance. The value of light is proportional to the voltage of the light bulb. If the voltage of the bulb is high, the longevity of the bulb is low.

Recently the gas light bulb available in the market includes a reflective shade in combination with a gas light bulb unit. The cost of such light bulb is high, and the high cost of the light bulb has invited many comments. Accordingly, it is an object of the present invention to provide a gas light bulb of high luminance which increases the longevity of the light bulb, reducing the need of replacement of new light bulb, which is equivalent to lowering the cost of operation.

### SUMMARY OF THE INVENTION

The primary purpose of the present invention is to provide a high luminance gas light bulb comprising a reflective shade and light bulb units mounted and supported within the reflective shade, characterized in that the internal surface of the reflective shade is provided with reflective mirror and the center position of the reflective shade is extended to form a neck portion and the light bulb includes at least two rows of light bulb units, and each light bulb unit has a space for filling with a gas and the space includes a first electrode and a second electrode, and the first and the second electrode are respectively supported and positioned by a conductor, and the conductor is connected to a metallic conductive wire as an electrical point.

Yet still another object of the present invention is to provide a gas light bulb of high luminance, wherein the reflective shade is a glass housing with an internal surface which is a reflective mirror and the wall of the glass housing has a through hole for a light bulb conductive wire.

Another object of the present invention is to provide a gas light bulb of high luminance, wherein at least two light bulbs units are arranged in a straight line configuration.

A further object of the present invention is to provide a gas light bulb of high luminance, wherein at least two light bulb units are arranged in parallel.

Another further object of the present invention is to provide a gas light bulb of high luminance, wherein the reflective mirror of the reflective shade is further divided into at least two reflective surfaces of different height.

Yet another object of the present invention is to provide a gas light bulb of high luminance, wherein at least two light bulb units include simultaneously lighted configuration or individual light configuration light bulbs.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a sectional view illustrating the entire structure of the light bulb of the present invention.

FIG. 2 is a schematic view illustrating the light bulb unit of the present invention.

FIG. 3 is a sectional view of another embodiment of light bulb in accordance with the present invention.

FIG. 4 is a schematic diagram illustrating the light bulb of FIG. 3 being mounted onto a reflective shade in accordance with the present invention.

FIG. 5 is a schematic view illustrating another configuration of the light bulb together with a reflective shade of the present invention.

FIG. 6 is a schematic view illustrating a reflective shade in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

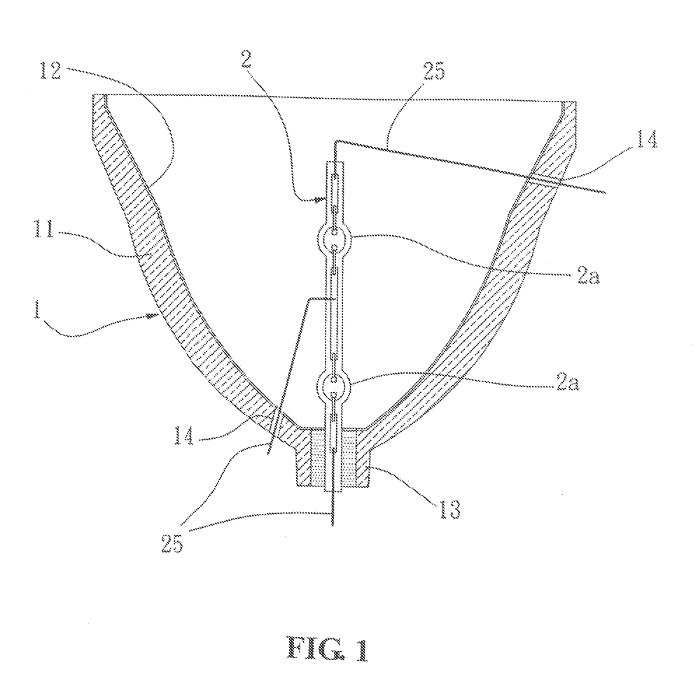

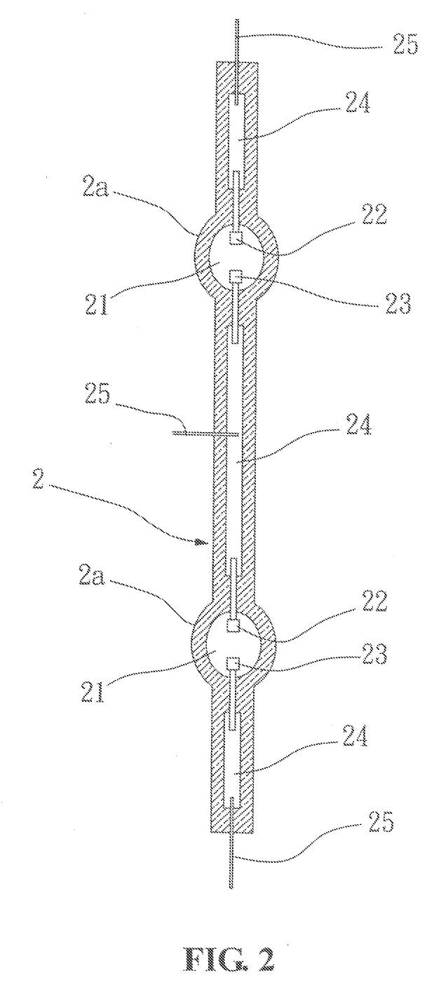

Referring to the FIGS, FIGS. 1 and 2 illustrate a first preferred embodiment of a gas light bulb of the present invention. The light bulb includes a reflective shade 1, a light bulb 2 mounted within the reflective shade.

The reflective shade 1 is substantially a cup-like glass housing 11 and a reflective mirror 12 formed within the surface of the glass housing 11. The center position of the glass housing 11 is extended to form a neck portion 13 for the linkage of one end of the light bulb 2, and the wall of the glass housing is provided with through hole 14 for the passage of metallic conductive wire 25 of the light bulb 2.

The light bulb 2 includes at least two rows of light bulb units 2a, and the light bulb unit 2a has a space 21 for the filling of a gas and the space 21 is provided with a first electrode 22 and a second electrode 23. The first and the second electrode 22, 23 are respectively supported and positioned by a conductor 24, and each conductor 24 is connected to a metallic conductive wire 25 as an electrical point.

In accordance with the present invention, when at least two of the light bulb units 2a within the reflective shade 1 are lighted at the same time, light rays of the multiple light bulb units 2a are focus and reflected to provide a high luminance illumination.

In the first preferred embodiment of the present invention, the luminance produced by the light bulb is proportional to the voltage of the light bulb unit 2a and the number of the light bulb unit 2a. For example, if two 100-volt light bulb units 2a are light simultaneously will generate equivalent or approximately equivalent to that of a conventional 200 volt light bulb. Thus, the light bulb of the present invention can control the light illuminance, and most importantly a plurality of low voltage light bulb unit 2a are used to generate the effect of high luminance. This will mitigate the drawback of a high voltage light bulb in producing a high voltage light, and to overcome the drawback of low longevity of the conventional light bulb.

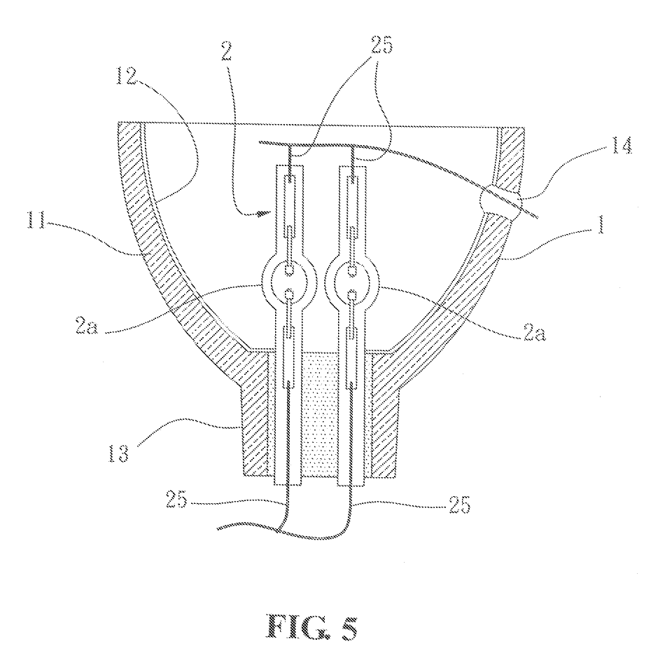

Referring again to FIGS. 1 and 2, the light bulb 2 includes at least two light bulb units 2a arranged in a straight line to form as a unit, or as shown in FIG. 5, at least two light bulbs 2a are arranged in parallel within the reflective shade 1. The above configuration of light bulbs in accordance with the present invention could attain the effect of high luminance of light bulbs.

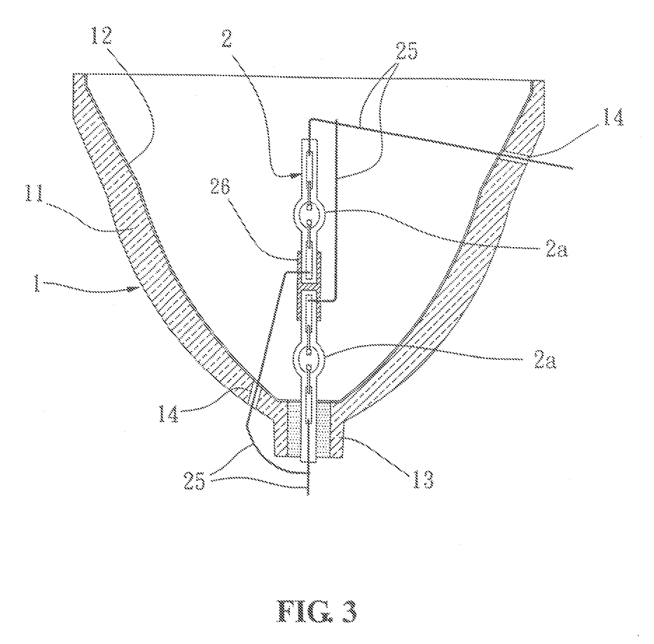

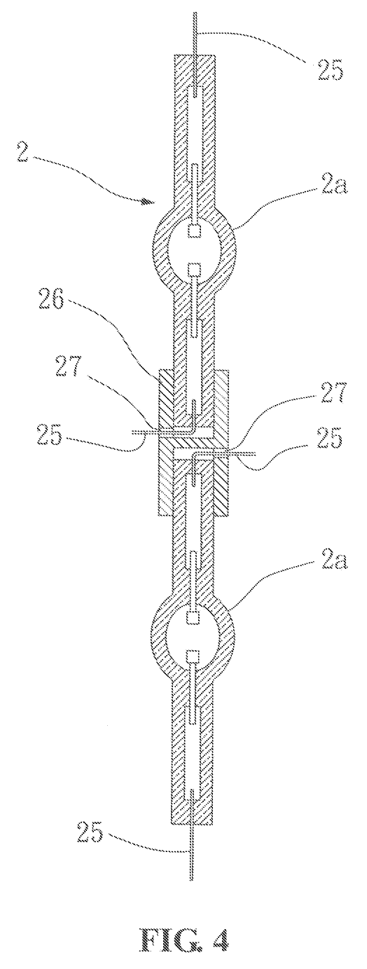

Referring to FIGS. 3 and 4, the light bulb units 2a are connected by using a high temperature resistant fitting 26 having a through hole 27 for a metallic conductive wire to provide connection at the end portion of the two light bulb units 2a. This type of sectional connection will improve the low power gas light bulb connection. In other words, the light bulb unit 2a of the present invention can be manufactured easily.

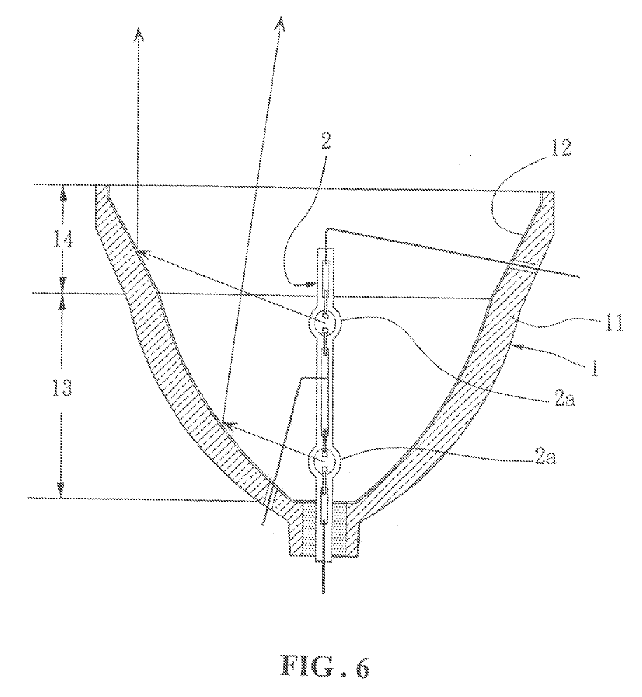

Referring to FIG. 6, the reflective mirror 12 of the reflective shade 1 can be formed from two reflective faces 13, 14 of different height. Thus, the light bulb unit 2a of different height will provide a better focus of light.

In accordance with the present invention, at least two light bulb units 2a are lighted simultaneously to provide high luminance. However, in practical, at least two light bulb units 2a can further include individually controlled or lighted light bulb units 2a to provide high luminance effect of the light bulb.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A high luminance gas light bulb comprising a reflective shade and light bulb units mounted and supported within the reflective shade, characterized in that the internal surface of the reflective shade is provided with reflective mirror and the center position of the reflective shade is extended to form a neck portion and the light bulb includes at least two rows of light bulb units, and each light bulb unit has a space for filling with a gas and the space includes a first electrode and a second electrode, and the first and the second electrode are respectively supported and positioned by a conductor, and the conductor is connected to a metallic conductive wire as an electrical point.

2. The high luminance gas light bulb of claim 1, wherein the reflective shade is a glass housing with an internal surface which is a reflective mirror and the wall of the glass housing has a through hole for a light bulb conductive wire.

3. The high luminance gas light bulb of claim 1, wherein at least two light bulbs units are arranged in a straight line configuration.

4. The high luminance gas light bulb of claim 1, wherein at least two light bulb units are arranged in parallel.

5. The high luminance gas light bulb of claim 1, wherein the reflective mirror of the reflective shade is further divided into at least two reflective surfaces of different height.

6. The high luminance gas light bulb of claim 1, wherein at least two light bulb units include simultaneously lighted configuration or individual light configuration light bulbs.
